(19) United States
(12) Patent Application Publication
(10) Pub. No.: US 2006/0126345 A1
(43) Pub. Date: Jun. 15, 2006

(54) Removal-proof lamp cap

(76) Inventor: Chun-Tsun Chen, Shanghai (CN)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/301,851

(22) Filed: Dec. 12, 2005

(30) Foreign Application Priority Data
Dec. 15, 2004 (CN) 200410093035.0

(51) Int. Cl. F21V 11/00

(52) U.S. Cl. 362/353

(57) ABSTRACT

The present invention provides a removal-proof lamp cap and energy saving lamp including the cap.

### CROSS-REFERENCE TO RELATED APPLICATIONS

This application claims priority to Chinese application No. 200410093035.0, filed on Dec. 15, 2004, the teachings of which are incorporated herein by reference.

### TECHNICAL FIELD

This invention relates to a lighting lamp, particularly a removal-proof cap for a lighting lamp.

### BACKGROUND

For the lighting lamp, at present, there are Edison screw type and bayonet type available where the Edison screw bulb (or strip lamp) is most common. In the view that the energy-saving lamp can also join with the aforementioned Edison screw lamp holder, one screw union joint is set in one end of the existing cap for energy-saving lamp. Meanwhile one socket is set in the other end for inserting the union joint (plug) of the energy-saving luminous tube (including the electric circuit part) in order to joint the lamp cap directly with the luminous tube of energy-saving lamp (including the electric circuit part). If there is electric circuit part such as rectification circuit in the lamp cap whose cost is higher, energy-saving tube can only be replaced upon failures of no lamp cap damage. At present, the existing lamp cap can be screwed backward to be removed (removable) without theft-proof function and the cap can be taken away easily that is unfavorable for safekeeping of outdoor lamp cap such as in public places. In addition, the cap can also be lost due to user's carelessness because it can be removed, thus resulting in not only economic losses but also electronic. And as the world energy tenses up, there is a need for energy saving measures, e.g., using energy-saving lamp. As described above, the existing cap of energy-saving lamp can be replaced by ordinary lamp bulb without energy-saving function (luminous tube). And thus, after the energy-saving cap is uninstalled, the ordinary lamp without energy-saving features can also be used, which means the existing technology is incapable of limiting the application of lamp without energy-saving and encouraging the use of energy-saving lamps.

### SUMMARY

The technical problem to be resolved in this invention is to provide an energy-saving lamp cap which cannot be removed once installed.

In order to resolve the above technical problem, a removal-proof lamp cap is provided herein, comprising (1) a main part; (2) a union joint which connects with one end of the said main part and can fit with Edison screw lamp holder of ordinary bulb; and (3) a socket part which connects with the other end of the said main part and can contain the cap of energy-saving lamp. In the side face of the union joint, there is an opening where a space is set. In the space a block is set to prevent the union joint from screwing backward. The block, which is linked to the inside wall of the opening through a elastic part and linked in one end with a fixed shaft in the space, is capable of rotating around the shaft. A part of the block head is pushed out of the above mentioned opening by the elastic force from the elastic part when the block hasn't been screwed into the Edison screw lamp holder. When the above mentioned joint is screwed positively into the screw lamp holder, the above mentioned block can rotate around the mentioned shaft and fit into the opening of the mentioned space without affecting the screwing in of the cap. But when the cap is screwed reverse out, the above mentioned block can maintain a closer contact with the inside wall of the screw lamp holder and thus clamp on the inside wall of the screw lamp holder to prevent the joint from rotating backward.

The removal-proof lamp cap provided in this invention, having one opening space being set in the side face of the joint and one block being set in the mentioned opening which has no effect on the forward rotation of the joint head (screwing in), can effectively prevent the reverse screwing out of the joint head and thus prevent the installed lamp cap from being stolen.

### BRIEF DESCRIPTION OF DRAWINGS

FIG. 1 is the outline view of this invention.

FIG. 2 is the schematic view of the end face of socket in the energy-saving lamp in this invention.

FIG. 3 is the A-A section view of one example of this invention.

FIG. 4 is the A-A section view of another example of this invention.

FIG. 5 is the schematic view of the block in this invention.

### DETAILED DESCRIPTION OF EMBODIMENT

Referring to the figures, the following explains the examples of this invention in detail.

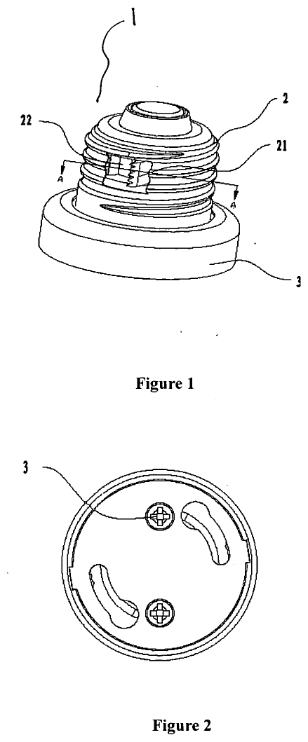

Referring to FIG. 1 and FIG. 2, a lamp cap in this invention includes main part 1, union joint 2 and plugging socket 3 for energy-saving lamp where union joint 2 forms one end of main part 1 (upper side) and can fit in an Edison screw lamp holder of ordinary bulb (not shown in the figure) (can be screwed directly). Socket 3 can fit in the plugging pin of the connector of an energy-saving lamp which is set on the other end of main part 1 (lower side) and includes two plugging sockets. There may be only one socket according to different energy-saving tube (if containing control circuits). The number, plugging mode and related size of the socket can be regulated as in related industrial or trade standards.

There is one opening 22 in the side face of joint 2, where one block 21 can be set to prevent the joint from screwing backward out of the screw lamp holder, which is described in detail in the following.

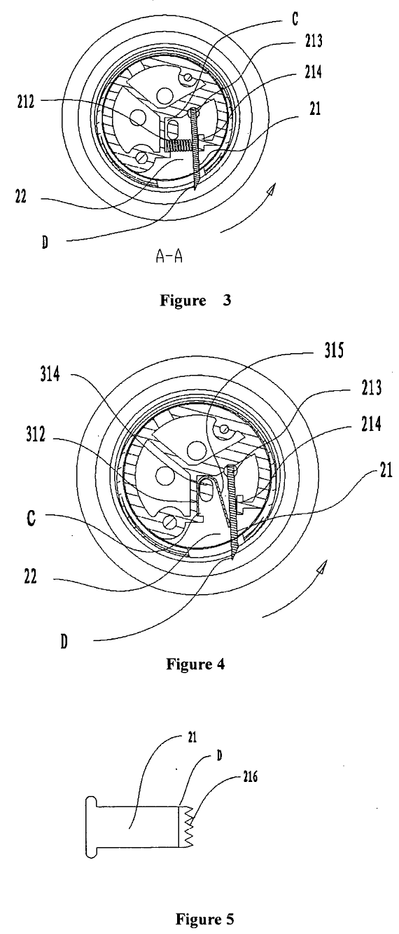

Referring to FIG. 3, there is a small space in opening 22 where a long strip block 21 is set. One end of block 21 connects with one fixed part in the opening through one fixed shaft 213. Hence, block 21 can rotate around shaft 213. One spring 212 is set in the left of block 21 whose one end is placed in notch C (to prevent block 21 from moving freely in the vertical surface) and the other end is maintained in contact with the middle of block 21. One convex block 214 is set in the right of block 21. When block 21 takes a position close to a vertical position (as in the position in FIG. 3), convex block 214 and the right of block 21 are close, and then the elastic force from spring 212 can cause block 21 to take the position as in FIG. 4 before it is screwed into the screw lamp holder. And thus, a part of clamp head D is pushed out of opening 22 in the side face of joint 2.

When joint 2 is screwed into an Edison screw lamp holder in the positive direction as in FIG. 3, the inside wall of the Edison screw lamp holder can exert an acting force on block 21 to the left, causing block 21 to rotate round shaft 213 clockwise to press spring 212. Because rotation shaft 213 is set in the eccentric position of the joint head, after block 21 rotates an angle, clamp head D of block 21 can be trapped in (fit in) opening 22, causing block 21 not to affect any more the positive screwing of joint 2.

When the joint head is screwed backward out, the inside wall of the Edison lamp holder can exert an acting force on block 21 to the right to make block 21 to contact with convex block 214, thereby causing block 21 not to rotate any more. If joint 2 is rotated further, the acting force between clamp D in block 21 and inside wall of the Edison screw holder can prevent joint 2 to rotate further. Therefore, joint 2 cannot be screwed out backward.

If joint 2 is rotated backward out (reverse), in order to prevent effectively the rotation of joint 2, in one embodiment, clamp D of block 21 is designed to have a zigzag shape (as shown in FIG. 5) which contains a plurality of cogs 216. Therefore, once joint 2 rotates backward by an outside force (e.g., a large outside force, cog 216 can puncture into the inside wall of screw lamp holder to prevent entirely the reverse rotation of joint 2.

In the above embodiment, one end of spring 212 can also connect with the fixed part of notch C, and the other end of spring 212 can also connect with middle position of block 21.

FIG. 4 is the schematic view of another embodiment. The difference between the embodiment as shown in FIG. 3 and the embodiment as shown in FIG. 4 lies in that there is plate spring 312 rather than spring 212 in it. Plate spring 312 can be bent to a C shape and is fixed by fixed axis 314. The end of arm 315 of plate spring 312 is in contact with the inside of block 21 (left side). An elastic force from plate spring 312 can cause block 21 to take the position as shown in FIG. 4 before being screwed into the Edison screw lamp holder to expose a part of clamp D out of the side opening of joint 2.

In similar manner, when joint 2 is screwed into screw lamp holder in the positive direction of screwing as shown in FIG. 4, the inside wall of screw lamp holder can exert an acting force on block 21 to the left to cause block 21 to rotate reverse round rotation spindle and to press on arm 315 of plate spring 312. By the elasticity of the plate spring, some elastic resistance is exerted on block 21. Meanwhile, because rotation axis 213 is set in the eccentric position of joint head, clamp D of block 21 can be trapped in the opening 22 after block 21 rotates an angle, thus causing block 21 no to affect any more on the positive rotation of joint 2.

If joint 2 is rotated reversely, the inside wall of the screw lamp holder can exert an acting force on block 21 to the right. And thus, block 21 and convex block 214 get contacted, and so block 21 cannot rotate any more. Then, if joint 2 is rotated further, clamp D of block 21 can prevent joint 2 from further rotation so as to prevent it from being screwed out reversely.

The removal-proof cap can be used in any type of light lamp. In some embodiments, the removal-proof cap can be used in an energy-saving lamp.

It is understood that the above embodiments can be changed in various forms by one of ordinary skill in the art to realize the same objectives of the invention without inventive work. These variations also fall within the protective limit by the following claims.

Where is claimed:

1. A removal-proof lamp cap, comprising
(1) a main part;
(2) a union joint which connects with one end of the main part and can fit in an Edison screw lamp holder of ordinary bulb; and
(3) a socket part which connects with the other end of the above main part and capable of containing the cap of an energy-saving lamp;
wherein in the side face of the union joint there is an opening where a space is set, and
wherein in the space, a block is set to prevent the joint from screwing out backward, the block, which is linked to the inside wall of the opening through an elastic part and further linked in one end to a fixed rotation shaft in the space, being capable of rotating around the axis,
wherein a part of the head of the block is pushed out of the opening by an elastic force from the elastic part when the block is screwed into the Edison screw lamp holder,
wherein, when the joint is screwed positively into the lamp holder, the block can rotate around the rotation shaft and fit into the opening of the space without affecting the screwing in the cap,
wherein, when the cap is screwed reversely out, the block is capable of having a closer contact with the inside wall of the screw lamp holder and clamping on the inside wall of the screw lamp holder to prevent the joint from rotating out backward.

2. The removal-proof lamp cap according to claim 1, wherein the elastic part is a spring having one end being posited in the notch in the said space and the other end being in contact with the middle of the said block.

3. The removal-proof lamp cap according to claim 1, wherein the elastic part is a plate spring, and
wherein the end of the arm of the plate spring is in contact with the said block.

4. The removal-proof lamp cap according to claim 1, wherein the said rotation shaft is set in the eccentric position of union joint, and
wherein, when the block is subject to rotation of an angle, the head of the block can be trapped in the said opening so that the head of the block will not affect the positive screwing in the union joint.

5. The removal-proof lamp cap according to claim 1, wherein the head of the block is designed to have a zigzag shape including a plurality of cogs, and
wherein, once the mentioned joint wherein is rotated backward by a large outside force, the cogs can puncture into the inside wall of an Edison screw lamp holder and prevent the backward rotation of the union joint.

6. The removal-proof lamp cap according to claim 1, wherein the elastic part is a spring having one end being connected with a fixed part in the space and the other end being connected with the middle part of the block.

7. A lamp having the removal-proof lamp cap of claim 1.
